(19) United States
(12) Patent Application Publication
(10) Pub. No.: US 2009/0095337 A1
(43) Pub. Date: Apr. 16, 2009

(54) MODULAR FOLDING DISPLAY BOOTH STRUCTURE

(76) Inventor: Mark C. Carter, Murieta, CA (US)

Correspondence Address: FULWIDER PATTON LLP, HOWARD HUGHES CENTER, 6060 CENTER DRIVE, TENTH FLOOR, LOS ANGELES, CA, 90045, US

(21) Appl. No.: 11/738,969

(22) Filed: Apr. 23, 2007

Related U.S. Application Data
(60) Provisional application No. 60/796,340, filed on Apr. 28, 2006.

(51) Int. Cl. E04H 15/48; G09F 17/00

(52) U.S. Cl. 135/143; 40/604

(57) ABSTRACT

The modular folding display booth structure includes a base frame structure with a plurality of legs and an upper folding framework, to which an upper display frame structure is removably mounted, to provide a temporary, folding display structure, such as an exhibitor booth or sales booth. The upper display frame structure may be formed as a canopy with a peak or gabled structure, or an open top structure, such as a vertically oriented banner, or inwardly or outwardly extending top portions.

### CROSS-REFERENCES TO RELATED APPLICATIONS

This application is based upon Provisional Patent Application No. 60/796,340, filed Apr. 28, 2006.

### BACKGROUND OF THE INVENTION

This invention relates generally to folding, collapsible structures, and more particularly relates to a modular folding display booth structure having a folding, collapsible base frame and an upper frame structure that is mounted on top of the base frame.

Temporary shelters that can be easily transported and rapidly set up at emergency sites can be particularly useful in providing temporary care and housing. Such shelters can also be useful for non-emergency outdoor gatherings, such as for temporary command posts, exhibit booths, sales booths, and the like. It would be desirable to provide a modular folding exhibit or display booth structure having a reusable basic folding, collapsible base frame, to which a variety of upper frame structures can be mounted as desired. The present invention fulfills these and other needs.

### SUMMARY OF THE INVENTION

Briefly, and in general terms, the invention provides for a modular folding display booth structure with base frame structure including a plurality of legs and an upper folding framework to which an upper display frame structure is removably mounted, to provide a temporary, folding display structure, such as for use as an exhibitor booth or sales booth.

The modular folding display booth structure includes a folding, collapsible base frame and an upper frame structure that is mounted on top of the base frame. The folding, collapsible base frame includes a collapsible framework, typically including a perimeter truss framework, which is connected to and supported by a plurality of legs to stabilize and support the folding, collapsible base frame.

The upper display frame structure is removably mounted to the top of the base frame, and may take a variety of forms, such as a canopy with a peak or gabled structure, or an open top such as a vertically oriented banner, or inwardly or outwardly extending top portions, for example. The modular nature of the booth structure also allows for the mounting of one or more side walls to the legs, the mounting of one or more side skirts to the legs, and the mounting of one or more flags to the upper display frame structure. These and other forms of the invention will become apparent from a consideration of the following detailed description and from the accompanying drawings.

### BRIEF DESCRIPTION OF THE DRAWINGS

FIG. 1 is a perspective view of a modular folding display booth structure with an upper display frame structure forming a canopy with a peak, according to the present invention.

FIG. 2 is a perspective view of a modular folding display booth structure with an upper display frame structure forming a canopy with a gabled structure, according to the present invention.

FIG. 3 is a perspective view of a modular folding display booth structure with an upper display frame structure forming an open top with a vertically oriented banner, according to the present invention.

FIG. 4 is a perspective view of a modular folding display booth structure with an upper display frame structure forming an open top with an inwardly extending top portion, according to the present invention.

FIG. 5 is a perspective view of a modular folding display booth structure with an upper display frame structure forming an open top with an outwardly extending top portion, according to the present invention.

FIG. 6 is a perspective view of a modular folding display booth structure with a canopy with a peak, a side wall and side skirts mounted to the legs, according to the present invention.

FIG. 7 is a perspective view of a modular folding display booth structure with one or more flags mounted to the upper display frame structure, according to the present invention.

FIG. 8 is a perspective view of a modular folding display booth structure with a canopy with a gable structure.

### DETAILED DESCRIPTION OF THE PREFERRED EMBODIMENTS

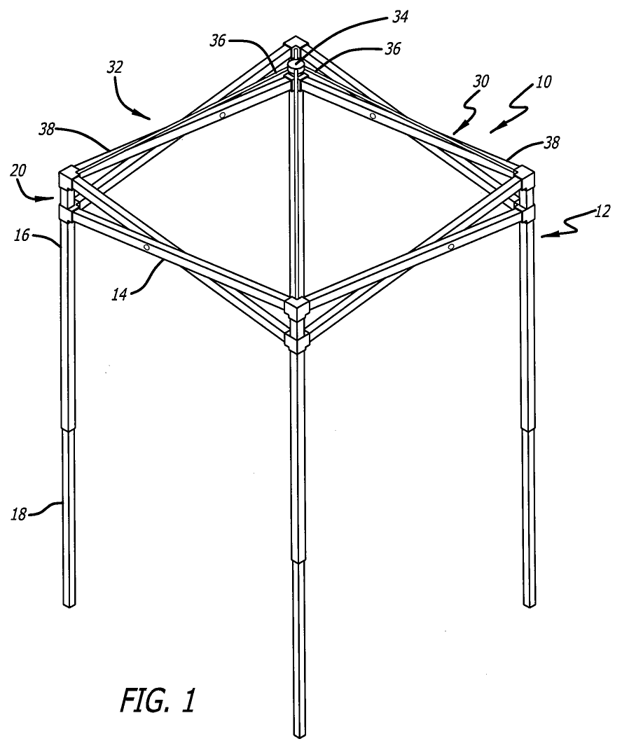

Referring to the drawings, a modular folding display booth structure 10 according to the present invention is illustrated in FIG. 1, and typically includes a collapsible base frame 12, with three or more sides 14, and three or more corners 16. The modular folding display booth structure typically has four sides and four corners. Legs 18 are typically provided at each corner to support a collapsible framework 20, typically including a perimeter truss framework connected to the legs to stabilize and support the modular folding display booth structure, as is described in U.S. Pat. No. 5,490,533, which is incorporated by reference herein.

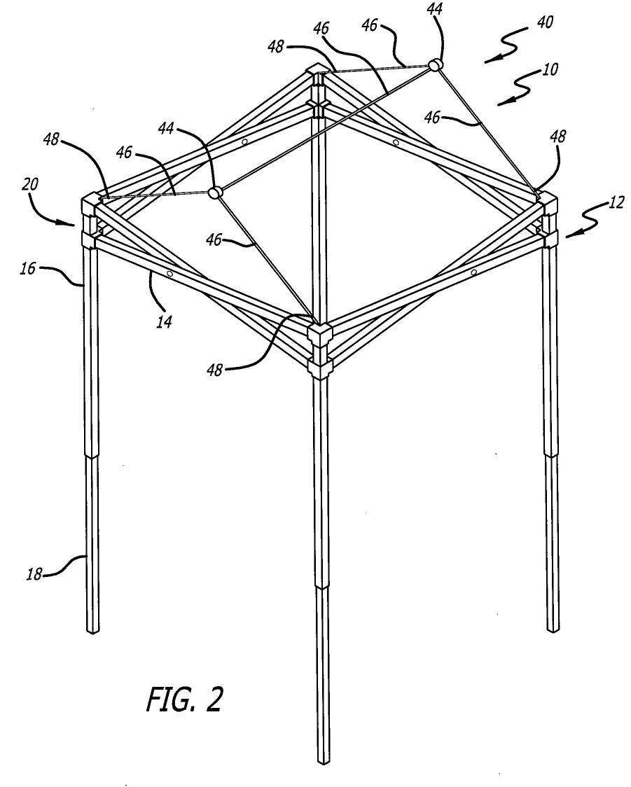

The upper display frame structure is removably mounted to the top of the legs and the base frame. In one aspect, illustrated in FIG. 1, the upper display frame structure 30 may be formed as a closed canopy with a central peak 34 supported by support arms 36 radiating from the central peak and connecting at their outer ends 38 to the upper ends of the legs or the perimeter truss framework. In another aspect, illustrated in FIGS. 2 and 8, the upper display frame structure 40 may be formed as a closed canopy with a gabled structure with a plurality of peaks 44, supported by support arms 46 radiating from the plurality of peaks and connecting at their outer ends 48 to the upper ends of the legs or the perimeter truss framework. The canopy portion is typically formed of nylon fabric, so as to be light and easily transportable, although the canopy portion may be made of other similar sheet materials, such as canvas, or other types of cloth fabric, or plastic.

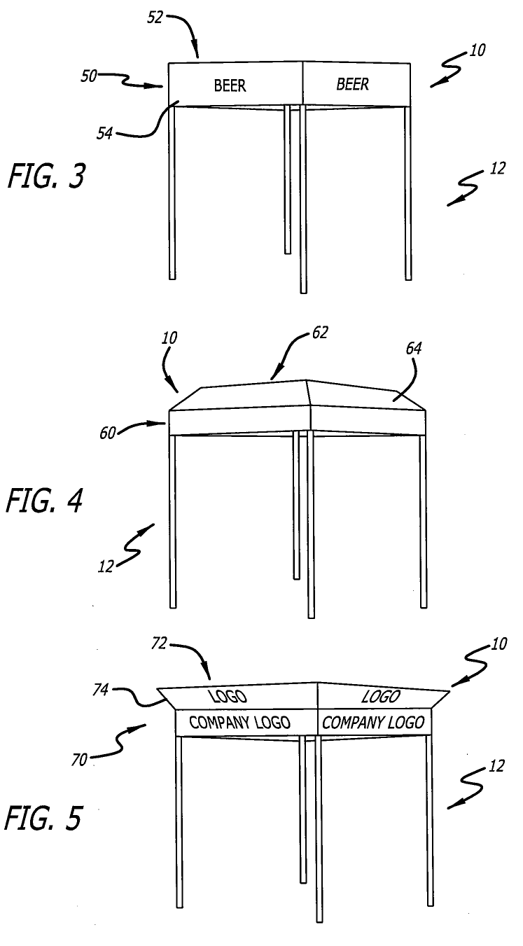

In another aspect, illustrated in FIG. 3, the upper display frame structure 50 of the folding display booth structure may be formed as an open top 52 with a vertically oriented banner 54. In another aspect, illustrated in FIG. 4, the upper display frame structure 60 of the folding display booth structure may be formed as an open top 62 with an inwardly extending top portion 64 forming a partial canopy, or as is illustrated in FIG. 5, the upper display frame structure 70 of the folding display booth structure may be formed as an open top 72 with an outwardly extending top portion 74 which may be used to display a banner, for example.

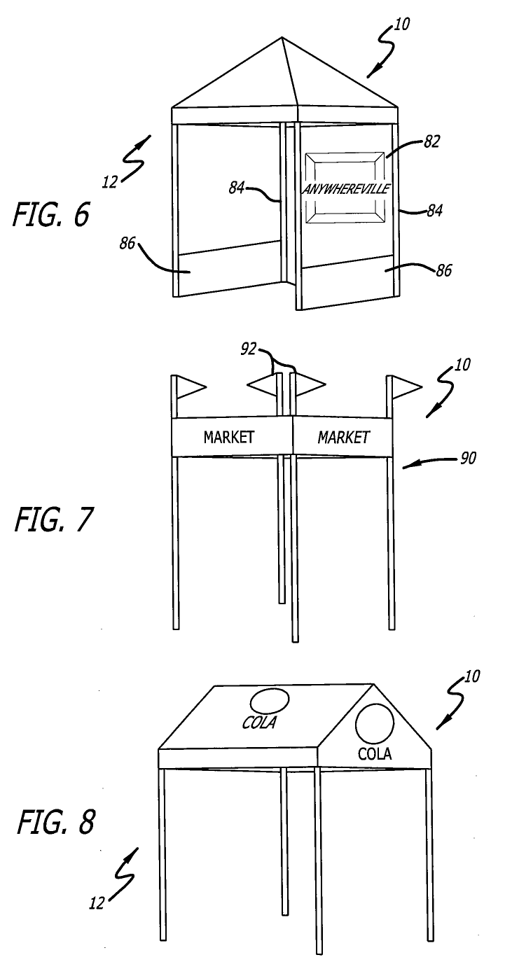

As is illustrated in FIG. 6, the collapsible base frame structure of the folding display booth structure also allows for the mounting of one or more side walls 82 to the legs 84, and the mounting of one or more side skirts 86 to the legs. The walls and side skirts are typically formed of a fabric material such as a polyester fabric, for example. As is illustrated in FIG. 7, the modular nature of the upper display frame structure 90 of the folding display booth structure also allows for the mounting of one or more flags 92 to the upper display frame structure.

It will be apparent from the foregoing that while particular forms of the invention have been illustrated and described, various modifications can be made without departing from the spirit and scope of the invention. Accordingly, it is not intended that the invention be limited, except as by the appended claims.

1. A modular folding display booth structure, comprising:
a folding base frame having a top side;
a plurality of legs connected to said base frame; and
an upper display frame structure removably mounted to the top side of the base frame.

2. The modular folding display booth structure of claim 1, wherein said base frame comprises a collapsible perimeter truss framework connected to and supported by said plurality of legs.

3. The modular folding display booth structure of claim 1, wherein said upper display frame structure comprises a canopy.

4. The modular folding display booth structure of claim 3, wherein said canopy has a peak.

5. The modular folding display booth structure of claim 3, wherein said canopy has a gabled structure.

6. The modular folding display booth structure of claim 1, wherein said upper display frame structure comprises an open top.

7. The modular folding display booth structure of claim 1, wherein said upper display frame structure further comprises a banner.

8. The modular folding display booth structure of claim 1, wherein said upper display frame structure further comprises an inwardly extending top portion.

9. The modular folding display booth structure of claim 1, wherein said upper display frame structure further comprises an outwardly extending top portion.

10. The modular folding display booth structure of claim 1, further comprising at least one side wall mounted to said plurality of legs.

11. The modular folding display booth structure of claim 1, further comprising at least one side skirt mounted to said plurality of legs.

12. A modular folding display booth structure, comprising:
a collapsible base frame having a top, at least three sides, and at least three corners;
a leg connected to each of said corners of said collapsible base frame, each said leg having an upper portion; and
an upper display frame structure removably mounted to the upper portion of said legs and the top of the base frame.

13. The modular folding display booth structure of claim 12, wherein said collapsible base frame comprises a collapsible perimeter truss framework connected to the legs to stabilize and support the modular folding display booth structure.

14. The modular folding display booth structure of claim 12, wherein said upper display frame structure comprises a closed canopy with a central peak, said closed canopy being supported by support arms radiating from the central peak, and said support arms having outer ends connected to the upper portions of the legs.

15. The modular folding display booth structure of claim 12, wherein said upper display frame structure comprises a closed canopy with a gabled structure with a plurality of peaks, said closed canopy being supported by support arms radiating from the plurality of peaks, and said support arms having outer ends connected to the upper portions of the legs.

16. The modular folding display booth structure of claim 12, wherein said canopy portion comprises an open top with a vertically oriented banner.

17. The modular folding display booth structure of claim 12, wherein said canopy portion comprises an open top with an inwardly extending top portion forming a partial canopy.

18. The modular folding display booth structure of claim 12, wherein said canopy portion comprises an open top with an outwardly extending top portion.

19. The modular folding display booth structure of claim 12, further comprising at least one side wall mounted to said legs.

20. The modular folding display booth structure of claim 12, further comprising at least one side skirt mounted to said legs.
